(19) United States
(12) Patent Application Publication
(10) Pub. No.: US 2012/0159350 A1
(43) Pub. Date: Jun. 21, 2012

(54) SYSTEMS AND METHODS FOR ENABLING VIRTUAL SOCIAL PROFILES

(75) Inventor: Nicolas Gaume, Paris (FR)

(73) Assignee: Mimesis Republic, Paris (FR)

(21) Appl. No.: 12/974,059

(22) Filed: Dec. 21, 2010

(51) Int. Cl. G06F 3/01; G06F 15/16

(52) U.S. Cl. 715/753

(57) ABSTRACT

A system and methods that enable virtual social profiles for digital representations of users. Comment/voting opportunities are provided so that users may vote or comment on profile contributions for a digital representation in a social online service. Such opportunities may also be managed by users. The act of voting on a comment/voting opportunity may increase a number of points associated with the comment. Once a comment opportunity is voted on by other users, it becomes a comment and contributes to a social profile of a targeted user. Consequentially, users may also be ranked and classified based on the perceptions of others.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of virtual social profiles for digital representations, and in particular to enabling social profiles based on third-party commenting or voting in a social online service.

### SUMMARY OF THE INVENTION

In an embodiment, a method provides opportunities to contribute to a virtual social profile of an user's digital representation. Opportunities to vote or comment on profile contributions for a digital representation, referred to herein as “comment opportunities” or “Com Opportunities,” may be displayed in a social online service. Such profile contributions may be comments, or “Coms,” that are voted on by other users. These Coms may include attributes or characteristics such as cool, nice, eccentric, proud, sexy, dark, fashion, party-animal, dorky, clumsy, loser, romantic, violent, ugly, smart, arty, sporty, and fun. These Coms may be represented aurally and/or visually, including representations displayed using graphics and/or text.

Users may be provided with software functionality that allows them to manage their own profiles. Com Opportunities may be deleted or promoted by a user before it is voted upon by other users. In an embodiment, once a Com Opportunity is voted on by other users, it becomes a Com and contributes to a social profile of a targeted user. The act of voting on a Com Opportunity may increase the number of points associated with a specific Com. Examples of the uses of such Com points are provided below.

In an embodiment, the Coms with the most votes may be used to generate a social profile for a user. A profile may depend on the top three listed Coms. For example, a ‘bad boy’ profile may result when the top three Coms include the combination of 135 points for a ‘cool’ Com, 90 points for a ‘sexy’ Com, and 50 points for an ‘evil’ Com. Other combinations, aggregations and representations of Coms may be used for various profile contribution schemes.

In an embodiment, a Com may contribute to a social profile when enough Com points have been reached. Such a point threshold for a Com may be predetermined.

Over time, many Com Opportunities can be activated on a targeted digital representation by the actions of the targeted user or that of other third-party users. The Com opportunities can be activated by the target user, other users or the system sua sponte; however, only other users can vote on the Com Opportunities to increase Coms points according to an embodiment. Once the Com Opportunities are active for the digital representation of a user, the user may promote the Com Opportunities to other voting channels or may delete the Com Opportunities. Other users may begin voting on the Com Opportunities once they are activated.

In an embodiment, a Com Opportunity Manager Component may enable Com Opportunities to be displayed, deleted, promoted or voted upon. The functionality of this component may be embedded in an online service. The Com Opportunity Manager Component may implement all or a subset of the functionalities for the Com Opportunities. In an embodiment, full or partial Com Opportunity Manager functionality may be provided by a third-party component, such as a Facebook Wall or other social network environment. The third-party component may have only display and vote functionality in an embodiment.

The virtual social profile can be used in various manners. One benefit of the disclosed system is that users may be ranked in order to compare one to another. For example, a user may be ranked to be the most “in love” compared to their friends. Virtual social profile also enable the ability to match-make users in activities, such as matching all the ‘partiers’ so that they can play together. In addition, virtual social profile may provide for the creation of virtual keys or entrance conditions for events or rooms. For example, only digital representations with social profiles that include ‘sexy’ and ‘fashion’ Coms may be allowed to a fashion show after party. Further, virtual social profiles may allow combinations of the top ranked Com entries in the profile to provide a limited subset of a very large community to be compared. As an example, a user may be the second best of all the sexy-dark-fashion users of the community. Consequentially, anybody can be distinguishable and potentially famous in a large community.

The virtual social profile may also be used by community managers, or any users who create events in their virtual rooms, as a way to target promotional communications to users who match their desired social profiles. For example, a room selector could be filtered by the virtual social profile allowing for custom messages and content to be displayed to users who match the desired virtual social profile. The virtual social profiles can be used as a way to automatically cluster people with identical or similar combinations of Coms. The virtual social profiles can be used by the community managers or users in the community to group or gather people who match a combination of Coms.

### BRIEF DESCRIPTION OF THE DRAWINGS

The foregoing and other objects, features, and advantages of the invention will be apparent from the following more particular description of embodiments as illustrated in the accompanying drawings, in which reference characters refer to the same parts throughout the various views. The drawings are not necessarily to scale, emphasis instead being placed upon illustrating principles of the invention.

FIG. 1 shows a flow chart of the use of a Com Opportunity, in accordance with certain embodiments of the invention.

FIG. 2 shows a flow chart of the creation of a Com Opportunity, in accordance with certain embodiments of the invention.

FIG. 3 shows a flow chart of the management of a Com Opportunity, in accordance with certain embodiments of the invention.

FIG. 4 shows a flow chart of the contribution of a Com Opportunity to a social profile, in accordance with certain embodiments of the invention.

FIG. 5 illustrates a virtual Com Opportunity generated by a program on a computer, in accordance with certain embodiments of the invention.

### DETAILED DESCRIPTION OF THE EMBODIMENTS

Reference will now be made in detail to the embodiments of the present invention, examples of which are illustrated in the accompanying drawings.

Traditionally, ranking is based on a user's own achievements rather than the actions of others, and a user profile is typically built manually by a user according to how they want to be perceived rather than being built iteratively by the actions of others and through the interactions with others. For example, a Massively Multiplayer Online Role-Playing Game (MMORPG) typically uses preset character classes that the user selects at the beginning of the game and accompanying characteristics that change through the user's own actions, such as a result of acquiring experience points. In contrast, the presently disclosed systems and methods provide a ranking and a profiling system that is based on the perceptions of others. The comments and votes of these other users generate a user's profile.

In an embodiment, a method provides social profiles for digital representations, including avatars, two-dimensional (2D) images, three-dimensional (3D) images, or realistic computer graphic representations. Such digital representations may be static or animated and may have power items, the power item being a virtual object that is associated with one or more predetermined virtual actions. Such power items are disclosed in detail in co-pending U.S. patent application Ser. No. 12/938,033, entitled “SYSTEMS AND METHODS FOR ENABLING VIRTUAL SOCIAL INTERACTIONS”, filed on Nov. 2, 2010, the entire disclosure of which is hereby incorporated by reference.

Such a digital representation may be rendered in a user interface of a network service including, but not limited to, a virtual world (such as Second Life, available from Linden Lab of San Francisco, Calif.), a social network service (such as Facebook, available from Facebook, Inc. of Palo Alto, Calif.), an online game (such as World of Warcraft, available from Blizzard Entertainment of Irvine, Calif.), game consoles (such as Xbox from Microsoft Corporation of Redmond, Wash. or Playstation from Sony Corporation of America, New York, N.Y.), an Internet webpage, a text message service (such as SMS or MMS), an instant messaging (IM) service (such as MSN available from Microsoft Corporation of Redmond, Wash., or Google Talk, available from Google Inc. of Mountain View, Calif.), an online blog, an online posting service (such as Twitter, available from Twitter, Inc. of San Francisco, Calif.), a mobile phone application or service, a teleconferencing service (such as video Skype), or a Web 2.0 application. The network service may include various paradigms, including web paradigms, 3D game paradigms, mobile service paradigms, and augmented reality paradigms.

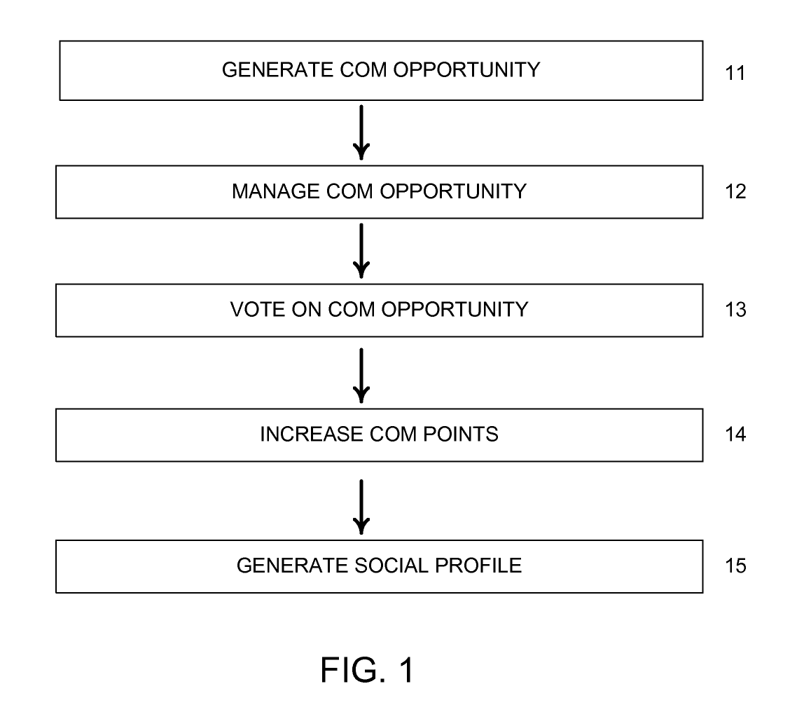

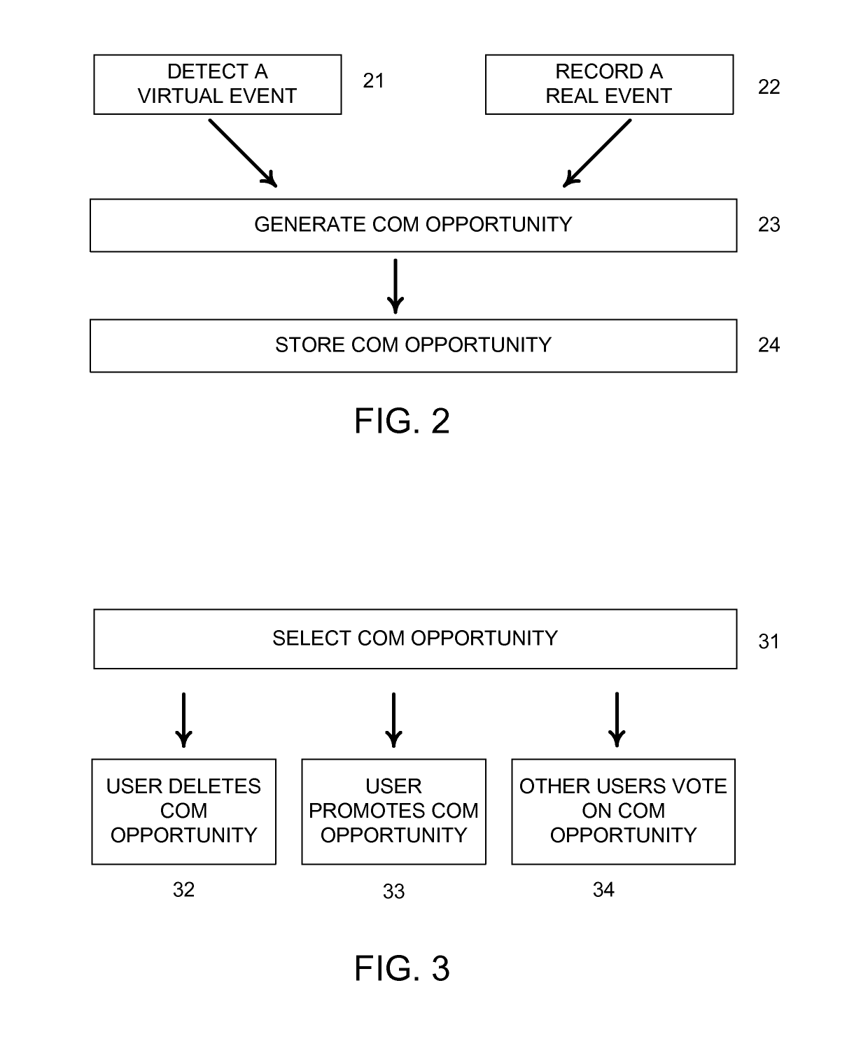

As shown in an embodiment depicted by FIG. 1, a Com Opportunity may be generated 11 and managed 12 by a user. Other users may vote on the Com Opportunity 13 in order to increase Com points 14 and generate a social profile 15. FIG. 2 depicts the detection of a virtual event 21, the recordation of a real event 22, the recordation of the virtual event, and the generation of a Com Opportunity 23, which may be stored 24. The virtual event 21 may be a significant event, including a virtual social interaction with other users, events based on contextual information of the virtual environment in the network service, or events triggered by other network services. Alternatively, a user may choose to generate a digital record 22 of an event in the real world in order to generate new Com Opportunities 23. For example, a digital message may be sent using a mobile phone to generate a Com Opportunity related to an activity such as taking a photo, choosing a Com, or generating an entry on a Fameline. Com Opportunities may also be generated during a teleconference/Skype call or during a MSN session.

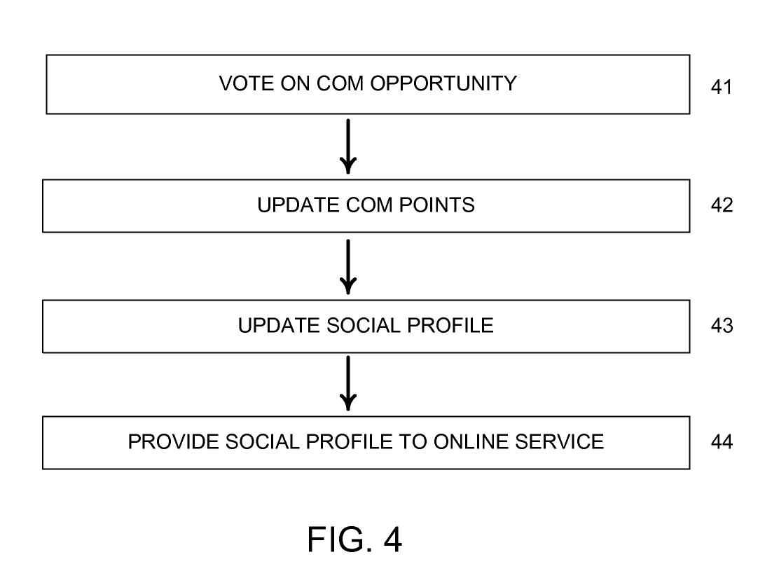

The Com Opportunity may be selected 31, as shown in FIG. 3 in order to manage the Com Opportunity via a Com Opportunity Manager Component. The user may delete 32 or promote 33 the Com Opportunity. Other users may vote on such a Com Opportunity 34. FIG. 4 illustrates how social profiles may be generated or updated as a result of other users voting on Com Opportunities 41 based on perceptions of the targeted user. As Com points are updated 42, social profiles may also be updated 43. Such social profiles may be provided to various network services, such as online services 44.

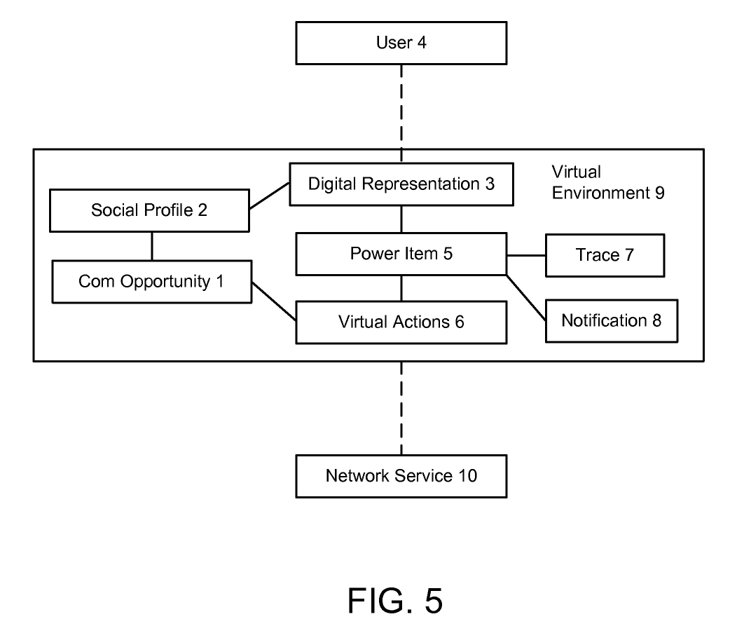

FIG. 5 illustrates a virtual Com Opportunity generated by a program on a computer. A Com Opportunity 1 may be contributed to a virtual social profile 2 for a digital representation 3 of a user 4. The digital representation 3 may have a power item 5 associated with one or more predetermined virtual actions 6. A trace 7 and a notification 8 may be provided for the power item 5 of the digital representation 2 based upon a virtual action 6 in the virtual environment 9 connected to a network service 10. A virtual action 6 may be considered to be the virtual event which triggered the generation of the Com Opportunity 1. The virtual action 6 may be based on a digital recordation or representation of an event in the real world.

Various embodiments of the disclosed systems and methods may be implemented in a wide range of network services. In a 3D virtual world embodiment, the users may interact synchronously (massively multiple online) and some of the interactions may activate the Com Opportunities. Some interactions may increase voting points on those Coms.

### EXAMPLE 1

One user hits a second user with a mallet power item and the mallet transfers a social tag representing a “loser” Com onto the second user. This makes the “loser” Com Opportunity active for voting both in the 3D and on the Fameline.

### EXAMPLE 2

A third user sees the “fashion” Com Opportunity on the first user, and she decides to vote on the first user by purchasing a +10 vote, activating it, and clicking on the first user to vote +10. Now the first user's “fashion” Com score goes up by 10 points.

### EXAMPLE 3

Avatar A enters a dancing room. He fulfils an activity goal installed in this room, being the tenth simultaneous dancer in there. The activity grants him the “winner” state—visible by the equipment of a golden crown on the avatar's head—that entitles him for a “proud” Com Opportunity. As he wanders by in some other public place, a friend of his sees the crown and decides to use a “vote” power item on him. This generic vote grants 10 points on the “proud” Com of the Avatar A profile.

In a Com Opportunity Manager Component embodiment, the Fameline may be provided. Such a Fameline is a component that is reused throughout the online service. For example, it may be provided in all a Facebook-type application, in a website, or even in a 3D virtual world user interface. All users may have a Fameline, and the Fameline may show all of the recently active Coms Opportunities for one user on a timeline and gives a second user (or users) an opportunity to vote on the active Coms Opportunities. Such a timeline may indicate relevant information like date, time, place, Com, who else was present, who initiated and who was the target of the Com, etc. Each vote raises the points on the Com by a fixed amount of points chosen by the voter.

A Com Opportunity Manager Component like the Fameline may offer an asynchronous way to raise a social profile compared the 3D virtual world way which is synchronous as the users interact in real-time 3D. Some Com Opportunity Manager Components may include the Fameline, a Fame Board, and a Cloud of Fame.

A Facebook wall can be used as a channel for voting because users are able to display, browse, and vote on Com Opportunities. The Facebook wall would be considered as a partial Com Opportunity Manager Component because users cannot promote Com Opportunities nor delete them from the Com Opportunity Management system (the user can only delete them from the Facebook wall).

### EXAMPLE 4

A second user is in a Mamba Voice Facebook application and decides to look at the Fameline for a first user that she played an activity with earlier that morning. The second user scrolls through the Fameline and finds the “party animal” Com Opportunity that was activated when they used the “drinking” power item together. The second user votes on the “party animal” Com raising the number of points by +25.

### EXAMPLE 5

A user U checks on his friend V's Fameboard page. He browses through the past gossip other people spread him using the Gossip Facebook application. One is about a topic he agrees on, it is about V being “dorky”. He sees three other users voted for this one and since he agrees he decides to use a vote action. With a single click, he adds 10 points to V's “dorky” Com in V's profile.

### EXAMPLE 6

When avatar A, belonging to user U, wins the dance activity by being the tenth dancer in the room, a trace of the event is created. This trace is made of a snapshot of the action along with a text defining the context (other people involved, the state that the user is in, time and place, etc.). To this trace is linked a “proud” Com Opportunity. Users can vote on this Com Opportunity, browsing through U's Fameline, to add points to the “proud” Com on the profile of user U.

In a Facebook-type applications embodiment, applications may have the Fameline for voting, but some will also be built around activating Coms Opportunities.

### EXAMPLE 7

A user goes to the Gossip Facebook application and chooses a rumor “Claims that he/she can't go to sleep without his/her teddy bear” which has an associated “angel” Com and sends the rumor to her friend. Now the “angle” Com Opportunity is active on the friend's Fameline.

In a Facebook Wall embodiment, the Fameline component allows users to choose Com Opportunities in their Fameline and to promote them to their Facebook wall in order to gain greater visibility of and voting on their preferred Coms. In addition, some Facebook applications and even the 3D virtual world can give the option to promote Coms Opportunities automatically to the users Facebook Wall or in the future, to other locations.

### EXAMPLE 8

During the Olympics, a first user goes to the Mamba Nation Facebook application, chooses their profile page's Fameline, and chooses “sporty” as the Com Opportunity they want to promote on their Facebook wall. The browsing and promotion process may use the representation and data to create an engaging selection experience and Facebook wall promotional display to increase the chances to be perceived as desired as “sporty”. Their friends see the “sporty” Com Opportunity in the form of a feed post on their Facebook Feed and then click the vote button.

### EXAMPLE 9

A first user in the 3D virtual world is zapped with a Fairy Wand Power Item by a second user that activates the “proud” Com Opportunity and the Com Opportunity now shows up on their Fameline. The first user immediately is presented with an option to promote the Com Opportunity to their Facebook Wall, selects the “Promote” button, and now the “proud” Com Opportunity appears on their Facebook Wall and can be voted upon.

Other embodiments may include new environments or locations where the disclosed systems and methods may be implemented. In an embodiment for mobile devices, the Fameline may be ported to a mobile device like the iPhone to allow users to see each other's Coms Opportunities and to vote on them. This functionality may be directly ported as a standalone application (primary functionality) or may be embedded in another application (secondary functionality). Future phone applications may be implemented using Coms and/or voting mechanics.

In social networks / online web services embodiments in addition to Facebook, functionality may be ported all or in part to new web service platforms. One example may be MySpace. A component for embedding a user's profile in another service may be provided. For example, a person may choose to embed their Social Profile into their blog so follower/contributors can follow/watch the changes in the blogger's profile.

For game console embodiments, all or part of this functionality may be ported to game consoles. For example, Coms or Profiles could be integrated into an Xbox Live arcade game or Playstation Portable (PSP) game with online functionality.

In 3D or 2D services, this profiling functionality may be used in a proprietary service or may be licensed to third-party services to contribute applications. For example, Coms, social profiles, and Com Opportunity Manager Components may be integrated into a teleconferencing (service like Skype) so that users chatting by text or video can browse profiles and Com Opportunities, vote, and activate Com Opportunities during their communication session.

There are various implementations for the mechanics and paths of the disclosed system. For example, even if a Com is activated by a Power Item in the 3D virtual world, it can be voted on immediately in the 3D virtual world or at a later time on the Fameline.

An embodiment may include administrating Coms Opportunities before they are activated and/or voted upon. In a 3D Virtual World embodiment, the Coms Opportunities can be configured/administrated through social tags to specific actions in the virtual world. Possible actions include state changes, activities outcomes, or any kind of remarkable event. Either us (as the service provider), power users, or groups of users can configure the social tags on Power Items. In a Facebook embodiment, the Coms can be configured by us or 3rd party developers as part of an application's content.

Embodiments may include activating Com Opportunities. In such a 3D Virtual World embodiment, the Com Opportunity can be activated on a second user or group of users when a first user triggers a Power Item.

### EXAMPLE 10

Avatar A uses a “cast a spell” Power Item on Avatar B. Avatar B is turned into a zombie: he gets the “zombie” state that includes face makeup, torn clothes and stiff walk. The Com Opportunity was linked by the customizer/administrator to the zombie state, “ugly”, is now attached to the avatar B as a Com Opportunity.

In a Facebook embodiment for activating Com Opportunities, the Com Opportunity can be activated when an action is taken in the Facebook application. The Com Opportunities may be a side effect of the Facebook application's own mechanics. For example, a user can send a rumor “Claims that he/she can't go to sleep without his/her teddy bear” which has an associated “nice” Com.

### EXAMPLE 11

User U posts gossip using the Gossip Facebook application, alleging User V stole his little sister pocket money. To this gossip, the administrator attached the “evil” Com Opportunity. Friends browsing V's Fameline in the Facebook application will be able to read the gossip, and when they agree, they can vote to increase his “evil” Com in his profile.

Embodiments may include voting on Coms. In such a 3D Virtual World embodiment, the Cams can be voted on by activating and using a voting action in the interface (for example, +10 action).

### EXAMPLE 12

Avatar A shows a “dark” Com Opportunity. Another Avatar B passes by, and decides to confirm this proposition. He selects the voting interface and uses a generic vote power item. The Avatar A then receives 10 more points on his “dark” Com.

### EXAMPLE 13

Avatar A displays a “dark” Com Opportunity. But a friend named B comes along and disagrees. B opens the Cams interface and selects a specific “nice” Com. As B activates the Com Opportunity, A gains 10 points for his “nice” Com, and nothing on his “dark” Com. A doesn't get the profile he wished, but the one friend B think fits better.

Voting embodiments may include a Fameline. Accordingly, the Coms can be voted upon directly on the Fameline.

Voting embodiments may include a Facebook Wall. If a user promoted a Com Opportunity to their Facebook wall, it may become visible for all of their friends to see and vote upon.

### EXAMPLE 14

User U promoted a trace featured in his Fameline into a Facebook feed post. The post shows the picture and the context of the original action, visible to everybody linked to this feed on Facebook. On the picture users can see U's Avatar being kissed by a girl. In the post is a text proposition “U may be romantic” and a link “I agree”. Any of his Facebook contacts clicking on the link “I agree” will grant his profile with some “romantic” Com points.

Embodiments may include a profile display and usage. These embodiments may be implemented in 3D Virtual Worlds, Famelines, Facebook Applications, Facebook Walls, room selectors, promotional channels, Blogs, mobile phones, teleconferencing services, and instant messaging services. Every possible service or component may display the combination of the top voted Coms in different ways depending on how they are used or the relevance of the information.

### EXAMPLE 15

For example, a 3D activity matchmaking service may choose to display an icon for the #1 most-voted Com with the 2nd and 3rd most-voted Com being ignored in the display, but all three are used in the matchmaking algorithm.

Embodiments of the disclosed system and method may involve various components of a computer system. The particular architecture or manner of interconnecting the components may vary. Certain systems may have fewer or more components. In an embodiment, a system may implement a central server and terminals/clients. Other configurations are possible, as will be readily apparent to those skilled in the art.

A system may include an inter-connect (e.g., bus and system core logic), which interconnects a microprocessor(s) and memory. The microprocessor may be coupled to cache memory. The inter-connect may interconnect the microprocessor(s) and the memory together and also interconnects them to a display controller and display device and to peripheral devices such as input/output (I/O) devices through an input/output controller(s). Typical I/O devices include mice, keyboards, modems, network interfaces, printers, scanners, video cameras and other devices which are well known in the art.

The inter-connect may include one or more buses connected to one another through various bridges, controllers and/or adapters. In an embodiment the I/O controller includes a USB (Universal Serial Bus) adapter for controlling USB peripherals, and/or an IEEE-1394 bus adapter for controlling IEEE-1394 peripherals.

The memory may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In an embodiment, the central servers may be implemented using one or more data processing systems. In some embodiments, one or more servers of the system may be replaced with the service of a peer to peer network or a cloud configuration of a plurality of data processing systems, or a network of distributed computing systems. The peer to peer network, or cloud based server system, can be collectively viewed as a server data processing system.

Embodiments of the disclosure can be implemented via the microprocessor(s) and/or the memory. For example, the functionalities described above can be partially implemented via hardware logic in the microprocessor(s) and partially using the instructions stored in the memory. Some embodiments are implemented using the microprocessor(s) without additional instructions stored in the memory. Some embodiments are implemented using the instructions stored in the memory for execution by one or more general purpose microprocessor(s). Thus, the disclosure is not limited to a specific configuration of hardware and/or software.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as computer programs. Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer readable storage medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

While the invention has been particularly shown and described with reference to a embodiment thereof, it will be understood by those skilled in the art that various changes in form and details may be made therein without departing from the spirit and scope of the invention.

1. A method for providing comment opportunities for digital representations in an online environment, comprising the steps:
automatically generating a comment opportunity, wherein the comment opportunity is associated with a virtual action;
storing the comment opportunity in a memory medium, wherein the memory medium is accessible to a computing device; and,
associating the comment opportunity with a digital representation, wherein the digital representation is a representation of a user in a network service;
wherein said steps of generating, storing and associating are performed by at least one physical device.

2. The method of claim 1, further comprising:
voting on the comment opportunity, wherein votes are cast by other users in the network service.

3. The method of claim 2, further comprising:
updating Com points for the digital representation.

4. The method of claim 3, further comprising:
updating a social profile for the digital representation.

5. A method for providing social profiles for digital representations, comprising the steps:
receiving votes on a comment opportunity, wherein the comment opportunity is associated with a digital representation, wherein the digital representation is a representation of a user in a network service, wherein the digital representation is displayed on a screen, wherein the screen is accessible to a computing device, wherein votes are cast by other users in the network service; and,
generating a social profile for the digital representation based on the votes;
wherein the receiving and generating steps are performed by at least one physical device.

6. The method of claim 1, further comprising:
managing the comment opportunity for the digital representation by the user.

7. The method of claim 1, further comprising:
providing the comment opportunity to other network services.

8. The method of claim 1, wherein the comment opportunity is displayed as a text.

9. The method of claim 1, wherein the comment opportunity is displayed as a two-dimensional (2D) image.

10. The method of claim 1, wherein the comment opportunity is displayed as a three-dimensional (3D) image.

11. The method of claim 1, wherein the comment opportunity is selected from a group consisting of the following attributes: cool, nice, eccentric, proud, sexy, dark, fashion, party-animal, dorky, clumsy, loser, romantic, violent, ugly, smart, arty, sporty, and fun.

12. The method of claim 5, wherein the comment opportunity is associated with a virtual action.

13. The method of claim 1, wherein the virtual action is selected from a group consisting of the following actions: a virtual social interaction between the digital representation and other digital representations of other users, virtual events based on contextual information of the virtual environment in the network service, virtual events triggered by other network services, or virtual events triggered by a generation of a digital record for a virtual event or a real-world event.

14. The method of claim 13, wherein the contextual information is selected from a group consisting of the following: a user status; a user state; a virtual social interaction between a plurality of digital representations in the network service; a virtual location or setting in the network service; or a virtual social context or relationship between a plurality of digital representations in the network service.

15. The method of claim 1, wherein the virtual action is based on a digital recordation of an event in the real world.

16. The method of claim 1, wherein the computing device is a smart phone or a personal digital assistant (PDA).

17. The method of claim 1, wherein the computing device is a computer.

18. The method of claim 1, wherein the digital representation is a representation selected from a group consisting of the following: a two-dimensional (2D) image; a three-dimensional (3D) image; a realistic computer graphic representation; an avatar; a static representation; or an animated representation.

19. The method of claim 1, wherein the network service is a service selected from a group consisting of the following: a virtual world; a social network service; an online game; an Internet webpage; a text message service; an instant messaging service; an online blog; a teleconferencing service; or an online posting service.

20. The method of claim 5, wherein the network service is a service selected from a group consisting of the following: a virtual world; a social network service; an online game; an Internet webpage; a text message service; an instant messaging service; an online blog; a teleconferencing service; or an online posting service.
